(19) United States
(12) Patent Application Publication
(10) Pub. No.: US 2011/0242015 A1
(43) Pub. Date: Oct. 6, 2011

(54) TOUCH INPUT DEVICE

(75) Inventor: YI-CHING LOU, Tu-Cheng (TW)

(73) Assignee: HON HAI PRECISION INDUSTRY CO., LTD., Tu-Cheng (TW)

(21) Appl. No.: 12/871,928

(22) Filed: Aug. 31, 2010

(30) Foreign Application Priority Data
Mar. 30, 2010 (CN) 201010136126.3

(51) Int. Cl. G06F 3/041; G08C 21/00

(52) U.S. Cl. 345/173; 178/18.01

(57) ABSTRACT

A touch input device, includes a touch panel, a number of slave touch detection circuits, and a master touch detection circuit. The touch panel is divided to a number of sub-panels and each sub-panel has a reference position. Each of the slave touch detection circuits is connected to one of the sub-panels and is configured for detecting user touch of one of the sub-panels, and producing a touch signal including the touch position of the one of the sub-panels in response to the users touch. The master touch detection circuit is connected to the number of slave touch detection circuits, and is configured for receiving the touch signals from the slave touch detection circuits and determining a touch position of the touch panel according to the touch signals and the reference position of the sub-panel connected to the slave touch detection circuit producing the touch signal.

### BACKGROUND

1. Technical Field

The present disclosure relates to touch input devices and, particularly, to a touch input device with improved touch resolution.

2. Description of Related Art

Nowadays, electronic devices equipped with touch input devices are very popular. Usually, touch points of the touch input devices are limited, for example, a touch input device of a mobile phone may have 20 touch points. If a touch input device is smaller, 20 touch points may be enough. However, for a larger touch input device, for example, a touch screen of a computer, 20 touch points may not be enough, and the touch resolution, namely, the number of the touch points in each unit of a touch input device, may not reach needed touch resolution. Increasing the number of the touch points can resolve the problem. However, the more touch points, the higher performance of a touch detection circuit is needed, which may increase the cost.

Therefore, it is desirable to provide a touch input device to overcome the above-mentioned limitations.

### BRIEF DESCRIPTION OF THE DRAWINGS

Many aspects of the present disclosure should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of a touch input device in accordance with an exemplary embodiment.

FIG. 2 is a schematic view showing a touch panel of the touch input device of FIG. 1, in accordance with an exemplary embodiment.

### DETAILED DESCRIPTION

Embodiments of the present disclosure will now be described in detail below, with reference to the accompanying drawings.

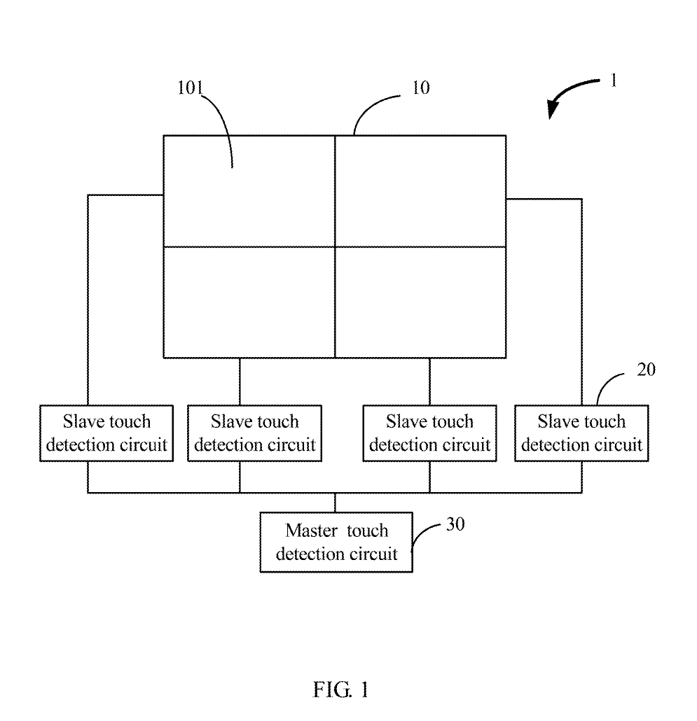

Referring to FIG. 1, a touch input device 1 includes a touch panel 10, a number of slave touch detection circuits 20, and a master touch detection circuit 30. In the embodiment, the touch panel 10 is divided into a number of sub-panels 101 and each sub-panel 101 has a reference position, and the number of the sub-panels 101 is equal to that of the slave touch detection circuits 20. Each slave touch detection circuit 20 is connected to one of the sub-panels 101, and the slave touch detection circuits 20 are connected to the master touch detection circuit 30. In this embodiment, the slave touch detection circuits 20 are connected to the master touch detection circuit 30 through an inter-integrated circuit (I²C) bus. The touch input device 1 can be applied in an electronic device (not shown), such as a mobile phone, a digital camera, a digital photo frame, or a portable computer.

Each slave touch detection circuit 20 is configured for detecting a user's touch on the sub-panel 101 connected to it and determining the touch position of the corresponding sub-panel 101 (hereinafter, the first touch position) in response to the user's touch, and produces a touch signal including the first touch position. The master touch detection circuit 30 is configured for receiving the touch signal from each slave touch detection circuit 20, and determining the touch position of the touch panel 10 according to the first touch position and the reference position of the sub-panel 101 connected to the slave touch detection circuit 20 producing the touch signal.

In the embodiment, there are four slave touch detection circuits 20 and four sub-panels 101, and the sub-panels 101 are arranged in a form of two rows and two columns. In the embodiment, the touch panel 10 is logically divided into the sub-panels 101 regardless of the physical layout of the sub-panels 101. In other embodiment, the touch panel 10 can be physically divided to several independent sub-panels 101.

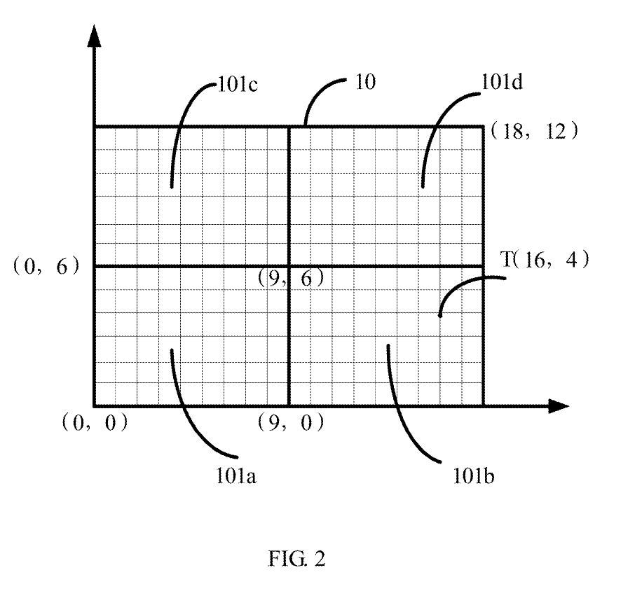

Referring to FIG. 2, each touch point of the touch panel 10 corresponds to a set of coordinates of a coordinate system. In the embodiment, the coordinate system is a Descartes coordinate system. In the embodiment, the four sub-panels 101 are sub-panel 101a, 101b, 101c, and 101d, and each of them has 70 touch points, which are arranged in a matrix pattern including ten columns and seven rows. The reference position of the sub-panels 101a, 101b, 101c, and 101d respectively are a coordinate of the Descartes coordinate system. In the embodiment, the reference position of the sub-panels 101a is (0, 0), the reference position of the sub-panels 101b is (9, 0), the reference position of the sub-panels 101c is (0, 6), and the reference position of the sub-panels 101d is (9, 6).

When a user touches a touchable point T which is located at the forth row and the seventh column of the sub-panel 101b, the slave touch detection circuit 20 connected to the sub-panel 101b determines the touch position of the sub-panel 101b, namely the first touch position is (7, 4) of the sub-panel 101b. The slave touch detection circuit 20 connected to the sub-panel 101b then produces and transmits a touch signal including the first touch position to the master detection circuit 30. The master detection circuit 30 receives the touch signal and determines a touch position of the touch panel 10 according to the first touch position and the reference position of the sub-panel 101b. In detail, the master detection circuit 30 determines the first touch position is (7, 4) and the reference position of the sub-panel 101b is (9, 0), then the master detection circuit 30 calculates the touch position of the touch panel 10 is (7 plus 9, 4 plus 0), namely (16, 4).

In the embodiment, if the user touches the boundary of two sub-panels 101, two slave touch detection circuits 20 respectively connected to the two sub-panels 101 each produces a touch signal including the touch position of corresponding sub-panel 101. The master touch detection circuit 30 can choose a touch signal randomly.

In the embodiment, because the touch panel 10 is divided into a number of sub-panels 101. Each slave touch detection circuit 20 is connected to one sub-panel 101 to detect touched touch points of the sub-panel 101, and the master touch detection circuit 30 determines coordinates of touched touch points according to touch signals from the slave touch detection circuits 20, thus there is no need to use a touch detection circuit with higher performance.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A touch input device comprising:
a touch panel divided to a plurality of sub-panels, each sub-panel having a reference position;
a plurality of slave touch detection circuits, each of the slave touch detection circuits being connected to one of the sub-panels and configured for detecting user touch of one of the sub-panels, and producing a touch signal comprising the touch position of the one of the sub-panels in response to the user touch; and
a master touch detection circuit connected to the plurality of slave touch detection circuits, and configured for receiving the touch signal from the slave touch detection circuit having detected the user touch and determining a touch position of the touch panel according to the touch signal and the reference position of the sub-panel connected to the slave touch detection circuit producing the touch signal.

2. The touch input device according to claim 1, wherein each touch point of the touch panel corresponds to a set of coordinates of a coordinate system and the reference positions of the sub-panels respectively correspond to a set of coordinates of the coordinate system.

3. The touch input device according to claim 1, wherein the touch panel is divided to four sub-panels, and the four sub-panels are arranged in a form of two rows and two columns.

4. The touch input device according to claim 1, wherein the slave touch detection circuits are connected to the master touch detection circuit via an inter-integrated circuit bus.

5. The touch input device according to claim 1, wherein the touch panel is logically divided to the sub-panels regardless of the physical layout of the sub-panels.

6. The touch input device according to claim 1, wherein the touch panel is physically divided to several independent sub-panels.

7. The touch input device according to claim 1, wherein if the user touches the boundary of two sub-panels, two slave touch detection circuits respectively connected to the two sub-panels each produces a touch signal comprising the touch position of corresponding sub-panel, the master touch detection circuit can choose a touch signal randomly.

8. An electronic device, comprising:
a touch input device comprising:
a touch panel divided to a plurality of sub-panels, each sub-panel having a reference position;
a plurality of slave touch detection circuits, each of the slave touch detection circuits being connected to one of the sub-panels and configured for detecting user touch of one of the sub-panels, and producing a touch signal comprising the touch position of the one of the sub-panels in response to the user touch; and
a master touch detection circuit connected to the plurality of slave touch detection circuits, and configured for receiving the touch signal from the slave touch detection circuits having detected the user touch and determining a touch position of the touch panel according to the touch signal and the reference position of the sub-panel connected to the slave touch detection circuit producing the touch signal.

9. The electronic device according to claim 8, wherein each touch point of the touch panel corresponds to a set of coordinates of a coordinate system and the reference positions of the sub-panels respectively correspond to a set of coordinates of the coordinate system.

10. The electronic device according to claim 8, wherein the touch panel is divided to four sub-panels, and the four sub-panels are arranged in a form of two rows and two columns.

11. The electronic device according to claim 8, wherein the slave touch detection circuits are connected to the master touch detection circuit via an inter-integrated circuit bus.

12. The electronic device according to claim 8, wherein the touch panel is logically divided to the sub-panels regardless of the physical layout of the sub-panels.

13. The electronic device according to claim 8, wherein the touch panel is physically divided to several independent sub-panels.

14. The electronic device according to claim 8, wherein the electronic device is selected from the group consisting of a mobile phone, a digital camera, a digital photo frame, and a portable computer.

15. The electronic device according to claim 8, wherein if the user touches the boundary of two sub-panels, two slave touch detection circuits respectively connected to the two sub-panels each produces a touch signal comprising the touch position of corresponding sub-panel, the master touch detection circuit can choose a touch signal randomly.
